(19) United States
(12) Patent Application Publication
(10) Pub. No.: US 2024/0196359 A1
(43) Pub. Date: Jun. 13, 2024

(54) Radio Network Node and Location Server for Use in a Wireless Communication Network

(71) Applicant: Telefonaktiebolaget LM Ericsson (publ), Stockholm (SE)

(72) Inventors: Yazid Lyazidi, London (GB); Åke Busin, Sollentuna (SE); Ritesh Shreevastav, Upplands Väsby (SE); Sinisa Ljubic, Zagreb (HR); Thomas Johansson, Åby (SE)

(21) Appl. No.: 18/554,217

(22) PCT Filed: Apr. 8, 2022
(86) PCT No.: PCT/EP2022/059473

§ 371 Date: Oct. 6, 2023

Related U.S. Application Data
(60) Provisional application No. 63/173,170, filed on Apr. 9, 2021.

(51) Int. Cl. H04W 64/00; H04W 24/10; H04W 76/20

(52) U.S. Cl. CPC H04W 64/00; H04W 24/10; H04W 76/20

(57) ABSTRACT

A radio network node (18) is configured for use in a wireless communication network (10). The radio network node (18) receives, from a location server (14), a request (16) for the radio network node (18) to report measurements usable to compute a location of a wireless device (12). The radio network node (18) transmits, to the location server (14), a message (20) that indicates the radio network node (18) is unable to report the measurements and that indicates a cause (22) of the radio network node (18) being unable to report the measurements. The cause (22) may be, for example, that the wireless device (12) has moved to another radio network node. Responsive to receiving the message (20), the location server (14) may transmit, to the other radio network node to which the wireless device (12) has moved, a request (16) for that radio network node to report measurements usable to compute a location of the wireless device (12).

### TECHNICAL FIELD

The present application relates generally to a wireless communication network and relates more specifically to a radio network node and a location server for use in such a network.

### BACKGROUND

A location server for a wireless communication network may request a radio network node to report measurements for determining the location of a wireless device. Distributing functionality for location services between the radio network node and the location server in this way provides efficiencies. Indeed, centralizing location determination in the location server simplifies the radio network node, as the radio network node need simply report requested measurements. However, the distribution of location services functionality nonetheless introduces challenges in how the location server is to handle circumstances in which the radio network node is unable to report the requested measurements.

### SUMMARY

According to embodiments herein, a radio network node informs a location server about the cause of the radio network node being unable to report measurements usable for determining the location of a wireless device. In particular, the radio network node may for example report the cause as being the wireless device entering a specified state (e.g., RRC inactive or RRC idle), unavailability of a context for the wireless device at the radio network node, or the wireless device having moved to another radio network node. The location server in some embodiments exploits the cause to adapt one or more parameters at the location server and/or to perform one or more actions, e.g., for optimizing its control of when and/or whether to request measurements from the radio network node for determining the location of the wireless device. In one or more embodiments, the location server in doing so may contribute to power savings at the wireless device and/or decrease consumption of air interface resources.

More particularly, embodiments herein include a method performed by a radio network node configured for use in a wireless communication network. The method comprises receiving, from a location server for the wireless communication network, a request for the radio network node to report measurements usable to compute a location of a wireless device. The method also comprises transmitting, to the location server, a message that indicates the radio network node is unable to report the measurements and that indicates a cause of the radio network node being unable to report the measurements. In some embodiments, the indicated cause is that the wireless device has moved to another radio network node.

In some embodiments, the measurements are enhanced cell identity, E-CID, measurements.

In some embodiments, the received request is a measurement initiation request.

In some embodiments, the transmitted message indicates the radio network node is unable to report the measurements by indicating that the radio network node is unable to initiate any of the measurements or is unable to instigate required radio resource control procedures to obtain the measurements from the wireless device.

In some embodiments, the transmitted message is a measurement initiation failure message or a measurement failure indication.

In some embodiments, the request is received using a Positioning Protocol between the radio network node and the location server. Additionally or alternatively, the message is transmitted using a Positioning Protocol between the radio network node and the location server.

In some embodiments, the transmitted message indicates the cause from a radio network layer perspective.

In some embodiments, the method further comprises, responsive to receiving the request, determining whether the radio network node is able to report the measurements. The method further comprises, based on determining that the radio network node is unable to report the measurements, determining a cause of the radio network node being unable to report the measurements. The method further comprises generating the message to be transmitted to indicate the determined cause.

Other embodiments herein include a method performed by a location server configured for use in a wireless communication network. The method comprises transmitting, from the location server to a radio network node in the wireless communication network, a request for the radio network node to report measurements usable to compute a location of a wireless device. The method also comprises receiving, from the radio network node, a message that indicates the radio network node is unable to report the measurements and that indicates a cause of the radio network node being unable to report the measurements. In some embodiments, the indicated cause is that the wireless device has moved to another radio network node.

In some embodiments, the measurements are enhanced cell identity, E-CID, measurements.

In some embodiments, the transmitted request is a measurement initiation request.

In some embodiments, the received message indicates the radio network node is unable to report the measurements by indicating that the radio network node is unable to initiate any of the measurements or is unable to instigate required radio resource control procedures to obtain the measurements from the wireless device.

In some embodiments, the received message is a measurement initiation failure message or a measurement failure indication.

In some embodiments, the request is transmitted using a Positioning Protocol between the radio network node and the location server. Additionally or alternatively, the message is received using a Positioning Protocol between the radio network node and the location server.

In some embodiments, the received message indicates the cause from a radio network layer perspective.

In some embodiments, the method further comprises storing the received message and/or information indicating the cause of the radio network node being unable to report the measurements.

In some embodiments, the method further comprises, responsive to receiving the message, transmitting, to the another radio network node, a request for the another radio network node to report measurements usable to compute a location of the wireless device.

Other embodiments herein include a radio network node configured for use in a wireless communication network. The radio network node is configured to receive, from a location server for the wireless communication network, a request for the radio network node to report measurements usable to compute a location of a wireless device. The radio network node is also configured to transmit, to the location server, a message that indicates the radio network node is unable to report the measurements and that indicates a cause of the radio network node being unable to report the measurements. In some embodiments, the indicated cause is that the wireless device has moved to another radio network node.

In some embodiments, the radio network node is configured to perform the steps described above for a radio network node.

Other embodiments herein include a location server configured for use in a wireless communication network. The location server is configured to transmit, from the location server to a radio network node in the wireless communication network, a request for the radio network node to report measurements usable to compute a location of a wireless device. The location server is also configured to receive, from the radio network node, a message that indicates the radio network node is unable to report the measurements and that indicates a cause of the radio network node being unable to report the measurements. In some embodiments, the indicated cause is that the wireless device has moved to another radio network node.

In some embodiments, the location server is configured to perform the steps described above for a location server.

Other embodiments herein include a computer program comprising instructions which, when executed by at least one processor of a radio network node, causes the radio network node to perform the steps described above for a radio network node. Other embodiments herein include a computer program comprising instructions which, when executed by at least one processor of a location server, causes the locations server to perform the steps described above for a location server. In one or more of these embodiments, a carrier containing the computer program is one of an electronic signal, optical signal, radio signal, or computer readable storage medium.

Other embodiments herein include a radio network node configured for use in a wireless communication network. The radio network node comprises communication circuitry and processing circuitry. The processing circuitry is configured to receive, from a location server for the wireless communication network, a request for the radio network node to report measurements usable to compute a location of a wireless device. The processing circuitry is also configured to transmit, to the location server, a message that indicates the radio network node is unable to report the measurements and that indicates a cause of the radio network node being unable to report the measurements. In some embodiments, the indicated cause is that the wireless device has moved to another radio network node

In some embodiments, the processing circuitry is configured to perform the steps described above for a radio network node.

Other embodiments herein include a location server configured for use in a wireless communication network. The location server comprises communication circuitry and processing circuitry. The processing circuitry is configured to transmit, from the location server to a radio network node in the wireless communication network, a request for the radio network node to report measurements usable to compute a location of a wireless device. The processing circuitry is also configured to receive, from the radio network node, a message that indicates the radio network node is unable to report the measurements and that indicates a cause of the radio network node being unable to report the measurements. In some embodiments, the indicated cause is that the wireless device has moved to another radio network node.

In some embodiments, the processing circuitry is configured to perform the steps described above for a location server.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network in accordance with some embodiments

FIG. 2 is a block diagram of an NR Positioning architecture according to some embodiments.

FIG. 3 is a call flow diagram of position measurement operations for the uplink E-CID method when the procedure is initiated by the LMF, according to some embodiments.

FIG. 4 is a logic flow diagram of a method performed by a radio network node according to some embodiments.

FIG. 5 is a logic flow diagram of a method performed by a location server according to some embodiments.

FIG. 6 is a block diagram of a radio network node according to some embodiments.

FIG. 7 is a block diagram of a location server according to some embodiments.

FIG. 8 is a block diagram of a communication system in accordance with some embodiments

FIG. 9 is a block diagram of a user equipment according to some embodiments.

FIG. 10 is a block diagram of a network node according to some embodiments.

### DETAILED DESCRIPTION

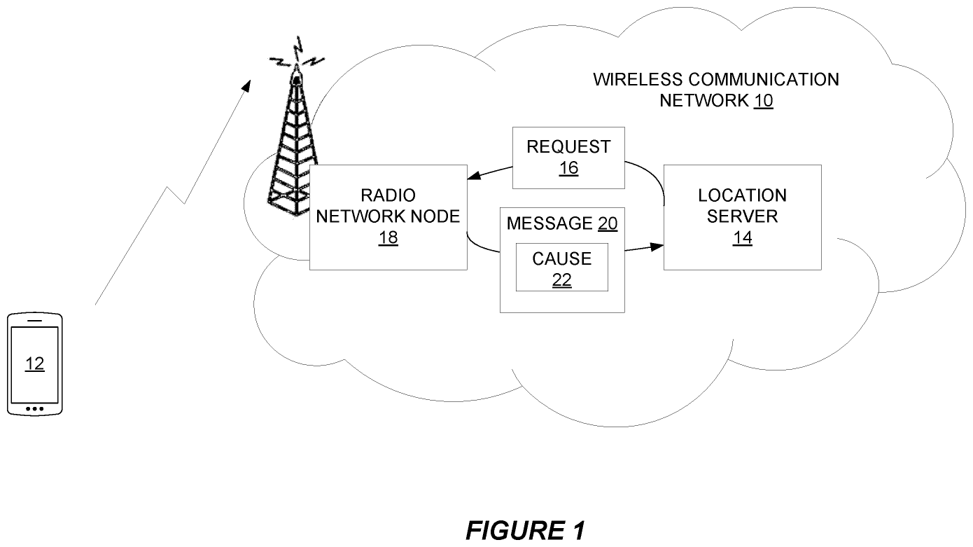

FIG. 1 shows a wireless communication network 10 configured to provide wireless communication service to a wireless device 12 according to some embodiments. As shown, the wireless communication network 10 includes a location server 14. In embodiments where the wireless communication network 10 is a 5G network, for example, the location server 14 is configured to implement a location management function (LMF).

The location server 14 as shown transmits a request 16 to a radio network node 18. The request 16 may be transmitted, for instance, using a Positioning Protocol between the location server 14 and the radio network node 18, such as a Long Term Evolution Positioning Protocol (LPP) or a New Radio Positioning Protocol (NRPP). In any event, the request 16 is a request for the radio network node 18 to report measurements usable to compute a location of the wireless device 12. In some embodiments, for example, the requested measurements are enhanced cell identity (E-CID) measurements. In these and other embodiments, the request 16 may be a measurement initiation request, e.g., an E-CID Measurement Initiation Request.

In some embodiments, though, the radio network node 18 is unable to report the measurements as requested. In this case, the radio network node 18 as shown is configured to transmit a message 20 to the location server, e.g., as a response to the request 16. The message 20 may be transmitted, for instance, using the Positioning Protocol between the location server 14 and the radio network node 18, such as LPP or NRPP. The message 20 indicates the radio network node 18 is unable to report the measurements according to the request 16. For example, the message 20 may indicate the radio network node 18 is unable to report the measurements by indicating that the radio network node 18 is unable to initiate any of the measurements or is unable to instigate required radio resource control (RRC) procedures to obtain the measurements from the wireless device 12. In these and other embodiments, the message 20 may for instance be a measurement initiation failure message or a measurement failure indication message, e.g., where the measurement failure indication message may be applicable for ongoing periodic measurements.

The message 20 also indicates a cause 22 of the radio network node 18 being unable to report the measurements. The cause 22 may, as one example, represent a cause from the radio network layer perspective.

According to some embodiments herein, the indicated cause 22 is the wireless device 12 entering a specified state. In embodiments where the cause 22 is the wireless device 12 entering a specified state, for example, the specified state may be a specified radio resource control (RRC) state, e.g., an RRC inactive state or an RRC idle state. In this case, then, the message 20 indicates the cause 22 of the radio network node 18 being unable to report the measurements is that the wireless device 12 has entered an RRC inactive state or is that the wireless device 12 has entered an RRC idle state.

Alternatively or additionally, the indicated cause 22 in other embodiments is unavailability of a context for the wireless device 12 at the radio network node 18. In embodiments where the cause 22 is unavailability of a context for the wireless device 12 at the radio network node 18, the cause 22 may more specifically indicate a reason for such unavailability. For example, in some embodiments, the cause 22 may be unavailability of the context for the wireless device 12 due to the context being released by the radio network node 18, e.g., and the wireless device 12 having entered an RRC idle state. In other embodiments, the cause 22 is unavailability of the context for the wireless device 12 due to the context being moved to another radio network node, e.g., to another gNB.

In such embodiments involving mobility to another radio network node, the cause 22 may be indicated either as (i) the context having moved to another radio network node; or (ii) the wireless device 12 having moved to another radio network node. Indeed, when the wireless device 12 moves to another radio network node, the context for the wireless device 12 is likewise moved to that other radio network node, so the cause 22 may be indicated in terms of mobility of the wireless device 12 itself or mobility of the context for the wireless device 12.

In any event, the location server 14 according to some embodiments herein exploits the cause 22 to adapt one or more parameters at the location server 14 and/or to perform one or more actions, e.g., for optimizing its control of when and/or whether to request measurements from the radio network node 18 for determining the location of the wireless device 12. In one or more embodiments, the location server 14 in doing so may contribute to power savings at the wireless device 12 and/or decrease consumption of air interface resources.

In some embodiments, for example, responsive to receiving the message 20, the location server 14 adapts a timing of when the radio network node 18 is to report measurements usable to compute a location of the wireless device 12. If the cause 22 is that the wireless device 12 has entered RRC inactive state or RRC idle state, for instance, the radio network node 18 may increase the time interval between which the radio network node 18 is to report measurements usable to compute a location of the wireless device 12. That is, the location server 14 may request that the radio network node 18 report such measurements at larger intervals, e.g., by sending an E-CID Measurement Initiation Request message at larger intervals. In some embodiments, then, the location server 14 exploits the cause 22 indicated in order to strategically reduce the number of times the location server 14 requests measurements from the radio network node 18 while the wireless device 12 is in a state that prevents the radio network node 18 from acquiring those measurements. Some embodiments may thereby help avoid wasting resources on requesting measurements from the radio network node 18 when the radio network node 18 is unable to fulfill that request.

In some embodiments, the location server 14 adapts the timing as described above by adapting a time interval between which the location server 14 transmits requests to the radio network node 18 for the radio network node 18 to report measurements usable to compute a location of the wireless device 12. For example, the location server 14 may adapt the timing with which it occasionally or periodically transmits E-CID Measurement Initiation Request messages to the radio network node 18 to request E-CID measurements for the wireless device 12. In other embodiments, by contrast, the location server 14 adapts the timing as described above by transmitting, to the radio network node 18, another request that requests the radio network node 18 to periodically report measurements usable to compute a location of the wireless device 12 according to a periodic interval that is different than a previous periodic interval indicated by a previous request transmitted to the radio network node 18. In this case, for example, the request 16 may request the radio network node 18 to periodically report measurements usable to compute the location of the wireless device 12 and may include a periodic interval according to which that periodic reporting is to be performed. Responsive to receiving the message 20 indicating the cause 22 of the radio network node's inability to report the requested measurements as being that the wireless device 12 has entered RRC inactive state or RRC idle state, the location server 14 may (immediately or at some point later) send another request to the radio network node 18 that includes a larger periodic interval for periodic reporting of the measurements.

In other embodiments, such as where the indicated cause 22 is that the wireless device 12 or the context for the wireless device 12 has moved to another radio network node, the location server 14 may transmit, to that other radio network node, a request for the other radio network node to report measurements usable to compute a location of the wireless device 12. The location server 14 in this case exploits the cause 22 to direct its request for measurements to the appropriate radio network node serving the wireless device 12. The cause 22 may thereby serve as early notice to the location server 14 that the wireless device 12 or the context for the wireless device 12 has moved and thereby prevent the location server 14 from wasting resources with further attempts to request the measurements from the radio network node 18. In fact, the cause 22 facilitates quicker acquisition by the location server 14 of the needed measurements, for reducing the latency with which the location of the wireless device 12 can be determined in the midst of wireless device mobility between radio network nodes.

In still other embodiments, such as where the indicated cause 22 is that the context for the wireless device 12 has been released at the radio network node 18 and/or the wireless device 12 has entered an RRC idle state, the location server 14 may wait to send another request, to the same or a different radio network node, until the wireless device 12 enters an RRC connected state. The location server 14 thereby exploits the cause 22 as the trigger for avoiding additional requests for the measurements until the wireless device 12 is in a state that will allow the radio network node 18 to acquire the requested measurements.

Note that, in some embodiments, the message 20 is configurable to indicate any of the causes above. In some embodiments, for example, the message 20 includes a cause field that indicates the cause 22. In this case, the cause field may be configurable to have any value included in a set of possible values. The possible values to which the cause field can be set may for example include two or more of the following: (i) a first value indicating the cause 22 as the wireless device 12 entering a radio resource control inactive state; (ii) a second value indicating the cause 22 as being the context for the wireless device 12 having moved to another radio network node; and (iii) a third value indicating the cause 22 as being the context for the wireless device 12 having been released at the radio network node 18 and/or the wireless device 12 having entered a radio resource control idle state. For example, the first value may be “UE in RRC_INACTIVE state”, the second value may be “UE Context moved”, and the third value may be “UE Context released”.

Consider for example a context in which the above embodiments are applicable in a NR network. In this case, the wireless device 12 is exemplified as a user equipment (UE), the radio network node 18 is exemplified as a gNB or NG-RAN node, and the location server 14 is exemplified as implementing an LMF.

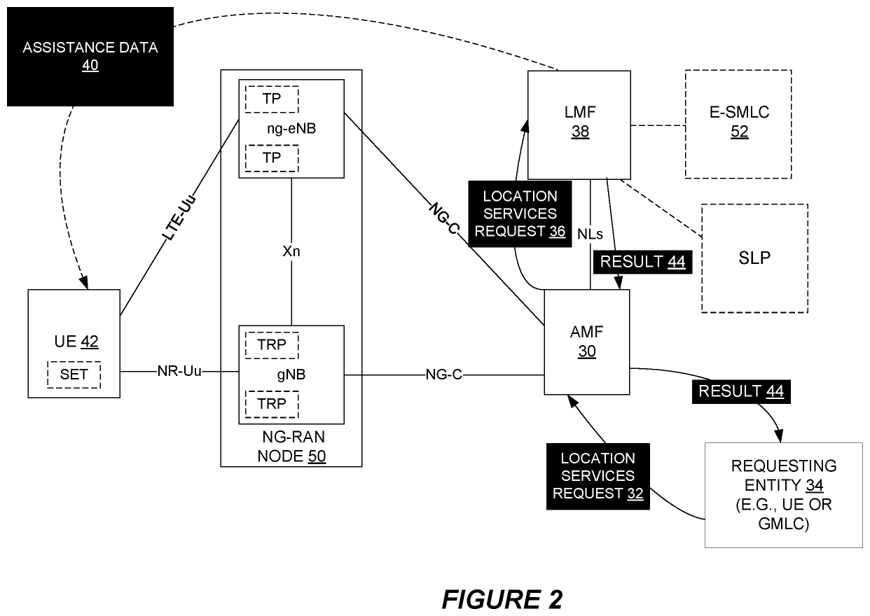

The NR Positioning architecture is presented in FIG. 2 (as per TS 38.305 v16.4.0). The Access and Mobility Function (AMF) 30 receives a request 32 for some location service associated with a particular target UE from another entity 34 (e.g., the Gateway Mobile Location Centre, GMLC, or UE) or the AMF itself decides to initiate some location service on behalf of a particular target UE (e.g., for an Internet Protocol Multimedia Subsystem, IMS, emergency call from the UE) as described in TS 23.502 v17.0.0 and TS 23.273 v17.0.0. The AMF 30 then sends a location services request 36 to an LMF 38. The LMF 38 processes the location services request 36, which may include transferring assistance data 40 to the target UE 42 to assist with UE-based and/or UE-assisted positioning and/or may include positioning of the target UE 42. The LMF 38 then returns the result 44 of the location service back to the AMF 30 (e.g., a position estimate for the UE). In the case of a location service requested by an entity 34 other than the AMF 30 (e.g., a GMLC or UE), the AMF 30 returns the location service result 44 to this entity.

An NG-RAN node 50 may control several TRPs/TPs, such as remote radio heads, or DL-PRS-only TPs for support of PRS-based terrestrial beacon system (TBS). Here, TRP stands for transmission reception point, TP stands for transmission point, DL stands for downlink, and PRS stands for positioning reference signal.

An LMF 38 may have a proprietary signalling connection to an Enhanced Serving Mobile Location Center (E-SMLC) 52 which may enable the LMF 38 to access information from E-UTRAN (e.g., to support the Observed Time Difference of Arrival, OTDOA, for E-UTRA positioning method using downlink measurements obtained by a target UE of signals from eNBs and/or PRS-only TPs in E-UTRAN).

The LTE Positioning Protocol (LPP) is the point-to-point communication protocol between the LMF 38 and a device. The NRPPa is the communication protocol between a gNB and LMF 38.

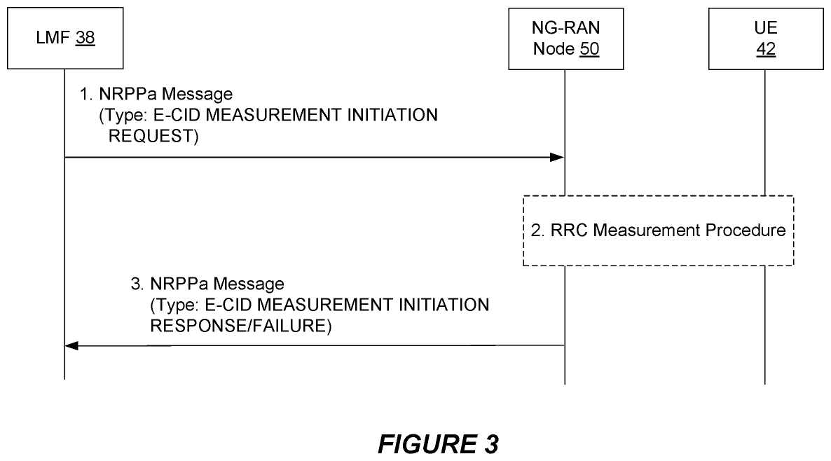

Some embodiments herein are applicable to the LMF-initiated Uplink NR E-CID procedure. FIG. 3 shows the position measurement operations for the uplink E-CID method when the procedure is initiated by the LMF 38.

In Step 1, the LMF 38 sends a NRPPa E-CID MEASUREMENT INITIATION REQUEST message to the NG-RAN node 50. This request includes an indication of E-CID measurements requested and whether the result is expected only once or periodically. In some embodiments, this NRPPa E-CID MEASUREMENT INITIATION REQUEST message is an example of the request 16 in FIG. 1.

In Step 2, if the LMF 38 in step (1) requested UE measurements (e.g., E-UTRA RSRP, E-UTRA RSRQ measurements, etc.), the NG-RAN node 50 may perform an RRC measurement procedure to configure the UE 42 to report the measurement information requested, e.g., as specified in TS 36.331 v16.4.0, TS 38.331 v16.4.1. Here, RSRP stands for reference signal received power and RSRQ stands for reference signal received quality.

In Step 3, if the result is expected only once and the NG-RAN node 50 initiates at least one of the E-CID measurements as requested, the NG-RAN node 50 sends an NRPPa E-CID MEASUREMENT INITIATION RESPONSE to the LMF 38, which includes the obtained E-CID measurements. If the result is expected periodically and the NG-RAN node 50 is able to initiate at least one of the E-CID measurements as requested, the NG-RAN node 50 sends an NRPPa E-CID MEASUREMENT INITIATION RESPONSE to the LMF 38, which does not include any result. The NG-RAN node 50 reports then the obtained measurements by initiating the E-CID Measurement Report procedure, with the requested periodicity. If the NG-RAN node 50 is unable to initiate any of the requested measurements as requested from the LMF 38 or is unable to instigate any of the required RRC procedures to obtain the requested measurements from the UE 42, the NG-RAN node 50 sends an NRPPa E-CID MEASUREMENT INITIATION FAILURE message providing the error reason. If the failure occurs during a periodic reporting, the NG-RAN node 50 sends an NRPPa E-CID MEASUREMENT FAILURE INDICATION message. The NRPPa E-CID MEASUREMENT INITIATION FAILURE message and the NRPPa E-CID MEASUREMENT FAILURE INDICATION message are different examples of the message 20 that the radio network node 18 in FIG. 1 may send to the location server 14, with the error reason corresponding to the cause 22 in FIG. 1.

Some embodiments support this UE positioning procedure under the scope of RRC_IDLE/RRC_INACTIVE positioning, i.e. performed when the UE 42 is in RRC_IDLE/RRC_INACTIVE. In this case, then, NRPPa may include a E-CID MEASUREMENT INITIATION REQUEST (UE-associated) and a E-CID MEASUREMENT REPORT (UE-associated).

In this context, when the LMF 38 sends the request for uplink (UL) NR E-CID positioning to the gNB, via the E-CID MEASUREMENT INITIATION REQUEST message, and the UE 42 enters RRC_INACTIVE state due to inactivity timer timeout, the gNB (as represented by the NG-RAN node 50 in FIG. 3) will send over NRPPa a E-CID MEASUREMENT INITIATION FAILURE (or E-CID MEASUREMENT FAILURE INDICATION for periodic measurement) to the LMF 38, since it is unable to configure and report any UE measurement. This failure can also happen when the UE performs handover to another node, or when the UE context is deleted. Some embodiments herein notably inform the LMF 38 of the reason(s), e.g., that it is because of the UE 42 having transitioned to the RRC Inactive state. That is, the gNB (represented by NG-RAN node 50) informs the LMF 38 directly of the cause of such measurement request or report failure. This can directly help the LMF 38 to optimize the handling of the measurement request, especially when the reporting is close to being terminated due to the UE 42 transitioning to Inactive state.

Some embodiments for example introduce new cause values: “UE in RRC_INACTIVE state”, “UE Context moved”, and “UE context released” in NRPPa to inform the requesting node that the E-CID measurements for positioning cannot be reported by the receiving node due to the UE 42 being in inactive mode, the UE 42 having moved, or the UE having been deleted in the RAN, respectively.

More particularly, some embodiments include new cause values “UE in RRC_INACTIVE state”, “UE Context moved”, and “UE context released” in the E-CID MEASUREMENT INITIATION FAILURE or E-CID MEASUREMENT FAILURE INDICATION message. Consider an example of TS 38.455 implementation below:

### 9.2.1 Cause

The purpose of the cause information element is to indicate the reason for a particular event for the whole protocol.

| | | | |
|---|---|---|---|
| IE/Group Name | Presence | Range | IE Type and Reference |

| | | |
|---|---|---|
| CHOICE Cause Group | M | |
| >Radio Network Layer | | |
| >>Radio Network | M | ENUMERATED |
| Layer Cause | | (Unspecified, Requested Item not Supported, |
| | | Requested Item Temporarily not Available, |
| | | . . ., UE in RRC INACTIVE state, UE Context |
| | | moved, UE context released) |
| >Protocol | | |
| >>Protocol Cause | M | ENUMERATED |
| | | (Transfer Syntax Error, |
| | | Abstract Syntax Error (Reject), |
| | | Abstract Syntax Error (Ignore and Notify), |
| | | Message not Compatible with Receiver State, |
| | | Semantic Error, |
| | | Unspecified, |
| | | Abstract Syntax Error (Falsely Constructed |
| | | Message), |
| | | . . .) |
| >Misc | | |
| >>Miscellaneous | M | ENUMERATED |
| Cause | | (Unspecified, . . .) |

The meaning of the different cause values is described in the following table. In general, “not supported” cause values indicate that the concerned capability is missing. On the other hand, “not available” cause values indicate that the concerned capability is present, but insufficient resources were available to perform the requested action.

| Radio Network Layer cause | Meaning |
|---|---|
| Unspecified | Sent when none of the above cause values applies but still |
| | the cause is Radio Network Layer related |
| Requested Item not Supported | The NG-RAN node does not support the requested |
| | measurement object, or cannot provide the requested |
| | information item. |
| Requested Item Temporarily not | The NG-RAN node can temporarily not provide the |
| Available | requested measurement object or information item. |
| UE in RRC INACTIVE state | The NG-RAN aborts the action due to the UE entering |
| | RRC INACTIVE state. |
| UE Context moved | UE context has moved to another gNB. |
| UE context released | UE context has been released and UE entered RRC IDLE |
| | state. |
| Protocol cause | Meaning |
| Abstract Syntax Error (Reject) | The received message included an abstract syntax error and |
| | the concerned criticality indicated “reject” |
| Abstract Syntax Error (Ignore and | The received message included an abstract syntax error and |
| Notify) | the concerned criticality indicated “ignore and notify” |
| Abstract syntax error (falsely | The received message contained IEs or IE groups in wrong |
| constructed message) | order or with too many occurrences |
| Message not Compatible with | The received message was not compatible with the receiver |
| Receiver State | state |
| Semantic Error | The received message included a semantic error |
| Transfer Syntax Error | The received message included a transfer syntax error |
| Unspecified | Sent when none of the above cause values applies but still |
| | the cause is Protocol related |
| Miscellaneous cause | Meaning |
| Unspecified | Sent when none of the above cause values applies and the |
| | cause is not related to any of the categories Radio Network |
| | Layer, Transport Network Layer or Protocol. |

When the gNB has received an E-CID MEASUREMENT INITIATION REQUEST and the gNB has received an Xn UE CONTEXT RELEASE message from another gNB due to the UE performing an inter-gNB mobility to a new gNB when moving from RRC_Inactive to RRC_Connected mode—the source gNB sends an E-CID MEASUREMENT INITIATION FAILURE message to the LMF 38 with the new cause value, e.g., cause value can be “UE Context moved”.

Generally, then, a gNB may operate as follows. Upon receiving an E-CID MEASUREMENT INITIATION REQUEST, and the UE 42 enters RRC-Inactive, the gNB sends an NRPPa E-CID MEASUREMENT INITIATION FAILURE (or E-CID MEASUREMENT FAILURE INDICATION for ongoing periodic measurements) to the LMF 38 with new cause value e.g., “UE in RRC_INACTIVE state”. Upon receiving an E-CID MEASUREMENT INITIATION REQUEST, and the UE 42 moves from a serving gNB to a target gNB, the serving gNB sends an NRPPa E-CID MEASUREMENT INITIATION FAILURE (or E-CID MEASUREMENT FAILURE INDICATION for ongoing periodic measurements) to the LMF 38 with new cause value e.g., “UE Context moved”. And upon receiving an E-CID MEASUREMENT INITIATION REQUEST, and e.g., the UE 42 is released to RRC IDLE state or the gNB has received a UE context release message from another node, the gNB sends an NRPPa E-CID MEASUREMENT INITIATION FAILURE (or E-CID MEASUREMENT FAILURE INDICATION for ongoing periodic measurements) to the LMF 38 with new cause value e.g., “UE context released”

Correspondingly, the LMF 38 receives the failure message, e.g., E-CID MEASUREMENT INITIATION FAILURE or E-CID MEASUREMENT FAILURE INDICATION message. The received failure message includes the new cause value. In some embodiments, the LMF 38 stores the failure message and/or the cause value. In case of cause value “UE in RRC_INACTIVE state”, the LMF 38 may take appropriate action for E-CID positioning, e.g., starting new (on-demand or periodic) E-CID and sending a E-CID MEASUREMENT INITIATION REQUEST message at large intervals. In case “UE Context moved” error cause value was received, the LMF 38 may send a new E-CID MEASUREMENT INITIATION REQUEST message towards the new node immediately. In case of cause value “UE context released” the LMF 38 can either wait longer until the UE 42 reappears or can retrigger the E-CID request immediately towards another node.

Generally, then, the LMF 38 can take actions to optimize the E-CID measurement request. For example, if the LMF 38 knows the UE 42 is in Inactive mode, the LMF 38 can start new E-CID MEASUREMENT INITIATION REQUEST (on demand or periodic) messages at large time intervals (using large interval in this case is does not interfere with RRC INACTIVE state handling in RAN, which aims to save UE power). If the LMF 38 receives a cause value indicating that the UE 42 has moved to another gNB, it can quickly send the E-CID request towards a new node.

Certain embodiments may provide one or more of the following technical advantage(s). The new cause value may advantageously allow the LMF 38 to optimize handling for E-CID periodic reporting or when the reporting is terminated. Optimized handling may contribute to UE power saving and decreased air interface resources. Moreover, some embodiments advantageously avoid 5G Core (5GC) impacts between the AMF 30 and LMF 38. Moreover, some embodiments keep the paradigm proper to NRPPa protocol.

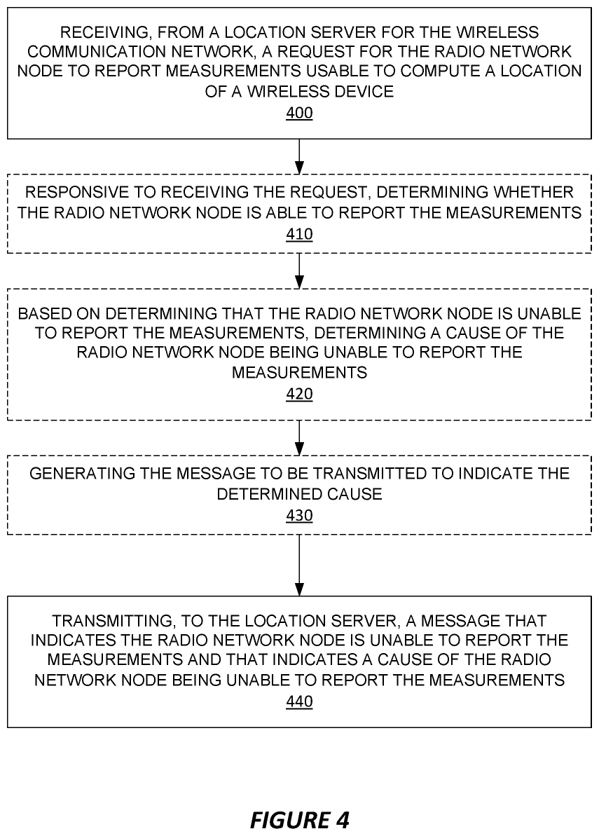

In view of the above modifications and variations, FIG. 4 depicts a method performed by a radio network node 18 configured for use in a wireless communication network 10 in accordance with particular embodiments. The method includes receiving, from a location server 14 for the wireless communication network 10, a request 16 for the radio network node 18 to report measurements usable to compute a location of a wireless device 12 (Block 400).

In some embodiments, the method comprises, responsive to receiving the request 16, determining whether the radio network node 18 is able to report the measurements (Block 410). Based on determining that the radio network node 18 is unable to report the measurements, the method may comprise determining a cause 22 of the radio network node 18 being unable to report the measurements (Block 420). The method in this case may further comprise generating a message 20 to be transmitted to indicate the determined cause 22 (Block 430).

In any event, the method as shown also comprises transmitting, to the location server 14, a message 20 that indicates the radio network node 18 is unable to report the measurements and that indicates a cause 22 of the radio network node 18 being unable to report the measurements (Block 440). In some embodiments, the indicated cause 22 is the wireless device 12 entering a specified state and/or is unavailability of a context for the wireless device 12 at the radio network node 18. Alternatively or additionally, the indicated cause 22 may be that the wireless device 12 has moved to another radio network node.

In some embodiments, the specified state is a radio resource control inactive state. In other embodiments, the specified state is a radio resource control idle state.

In some embodiments, the indicated cause 22 is unavailability of the context for the wireless device 12 due to the context being moved to another radio network node. In other embodiments, the indicated cause 22 is unavailability of the context for the wireless device 12 due to the context being released by the radio network node 18.

In some embodiments, the measurements are enhanced cell identity, E-CID, measurements.

In some embodiments, the received request 16 is a measurement initiation request.

In some embodiments, the transmitted message 20 indicates the radio network node 18 is unable to report the measurements by indicating that the radio network node 18 is unable to initiate any of the measurements or is unable to instigate required radio resource control procedures to obtain the measurements from the wireless device 12.

In some embodiments, the transmitted message 20 is a measurement initiation failure message or a measurement failure indication.

In some embodiments, the request 16 is received and/or the message 20 is transmitted using a Positioning Protocol between the radio network node 18 and the location server 14.

In some embodiments, the transmitted message 20 includes a cause field that indicates the cause. In one embodiment, the cause field is configurable to have any value included in a set of possible values, where the set of possible values comprises two or more of: (i) a first value indicating the cause as the wireless device entering a radio resource control inactive state; (ii) a second value indicating the cause as being the context for the wireless device having moved to another radio network node; and (iii) a third value indicating the cause as being the context for the wireless device having been released at the radio network node and/or the wireless device having entered a radio resource control idle state. For example, in some embodiments, the first value is “UE in RRC_INACTIVE state”, wherein the second value is “UE Context moved”, and wherein the third value is “UE Context released”.

In some embodiments, the transmitted message 20 indicates the cause from a radio network layer perspective.

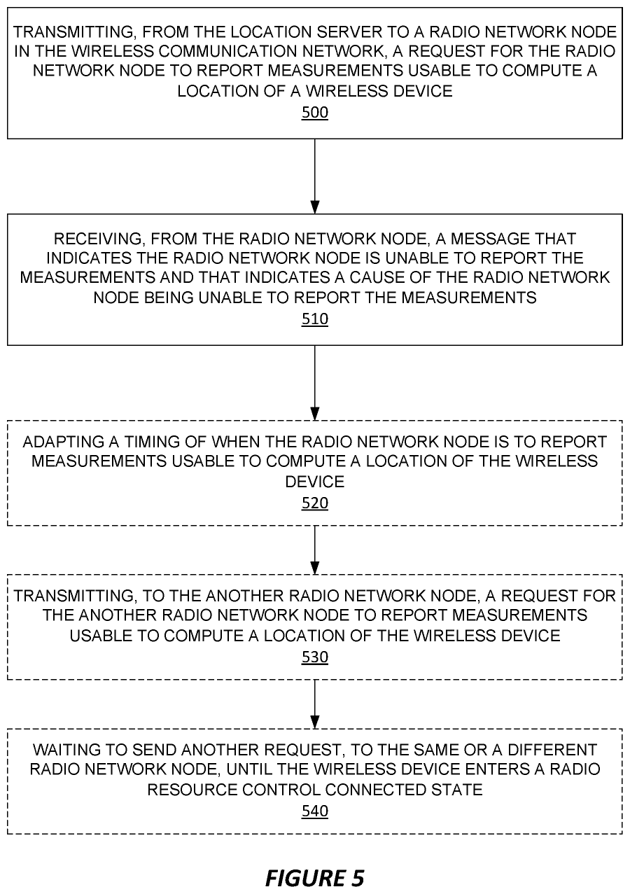

FIG. 5 depicts a corresponding method performed by a location server 14 configured for use in a wireless communication network 10 in accordance with other particular embodiments. The method includes transmitting, from the location server 14 to a radio network node 18 in the wireless communication network 10, a request 16 for the radio network node 18 to report measurements usable to compute a location of a wireless device 12 (Block 500). The method also comprises receiving, from the radio network node 18, a message 20 that indicates the radio network node 18 is unable to report the measurements and that indicates a cause 22 of the radio network node 18 being unable to report the measurements (Block 510). In some embodiments, the indicated cause 22 is the wireless device 12 entering a specified state and/or is unavailability of a context for the wireless device 12 at the radio network node 18. Alternatively or additionally, the indicated cause 22 may be that the wireless device 12 has moved to another radio network node.

In some embodiments, the method further comprises adapting a timing of when the radio network node 18 is to report measurements usable to compute a location of the wireless device 12 (Block 520). Alternatively or additionally, the method may further comprise transmitting, to another radio network node, a request for the another radio network node to report measurements usable to compute a location of the wireless device 12 (Block 530). Alternatively or additionally, the method may comprise waiting to send another request, to the same or a different radio network node, until the wireless device 12 enters a radio resource control connected state (Block 540).

In some embodiments, the specified state is a radio resource control inactive state. In other embodiments, the specified state is a radio resource control idle state.

In some embodiments, the indicated cause 22 is unavailability of the context for the wireless device 12 due to the context being moved to another radio network node. In other embodiments, the indicated cause 22 is unavailability of the context for the wireless device 12 due to the context being released by the radio network node 18.

In some embodiments, the measurements are enhanced cell identity, E-CID, measurements.

In some embodiments, the transmitted request 16 is a measurement initiation request. In some embodiments, the received message 20 indicates the radio network node 18 is unable to report the measurements by indicating that the radio network node 18 is unable to initiate any of the measurements or is unable to instigate required radio resource control procedures to obtain the measurements from the wireless device 12.

In some embodiments, the received message 20 is a measurement initiation failure message or a measurement failure indication.

In some embodiments, the request 16 is transmitted and/or the message 20 is received using a Positioning Protocol between the radio network node 18 and the location server 14.

In some embodiments, the received message 20 includes a cause field that indicates the cause 22. In one embodiment, for example, the cause field is configurable to have any value included in a set of possible values. In this case, the set of possible values comprises two or more of: (i) a first value indicating the cause as the wireless device entering a radio resource control inactive state; (ii) a second value indicating the cause as being the context for the wireless device having moved to another radio network node; and (iii) a third value indicating the cause as being the context for the wireless device having been released at the radio network node and/or the wireless device having entered a radio resource control idle state. For example, the first value may be “UE in RRC_INACTIVE state”, the second value may be “UE Context moved”, and the third value may be “UE Context released”.

In some embodiments, the received message 20 indicates the cause from a radio network layer perspective.

Embodiments herein also include corresponding apparatuses. Embodiments herein for instance include a radio network node 18 configured to perform any of the steps of any of the embodiments described above for the radio network node 18.

Embodiments also include a radio network node 18 comprising processing circuitry and power supply circuitry. The processing circuitry is configured to perform any of the steps of any of the embodiments described above for the radio network node 18. The power supply circuitry is configured to supply power to the radio network node 18.

Embodiments further include a radio network node 18 comprising processing circuitry. The processing circuitry is configured to perform any of the steps of any of the embodiments described above for the radio network node 18. In some embodiments, the radio network node 18 further comprises communication circuitry.

Embodiments further include a radio network node 18 comprising processing circuitry and memory. The memory contains instructions executable by the processing circuitry whereby the radio network node 18 is configured to perform any of the steps of any of the embodiments described above for the radio network node 18.

Embodiments herein also include a location server 14 configured to perform any of the steps of any of the embodiments described above for the location server 14.

Embodiments also include a location server 14 comprising processing circuitry and power supply circuitry. The processing circuitry is configured to perform any of the steps of any of the embodiments described above for the location server 14. The power supply circuitry is configured to supply power to the location server 14.

Embodiments further include a location server 14 comprising processing circuitry. The processing circuitry is configured to perform any of the steps of any of the embodiments described above for the location server 14. In some embodiments, the location server 14 further comprises communication circuitry.

Embodiments further include a location server 14 comprising processing circuitry and memory. The memory contains instructions executable by the processing circuitry whereby the location server 14 is configured to perform any of the steps of any of the embodiments described above for the location server 14.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

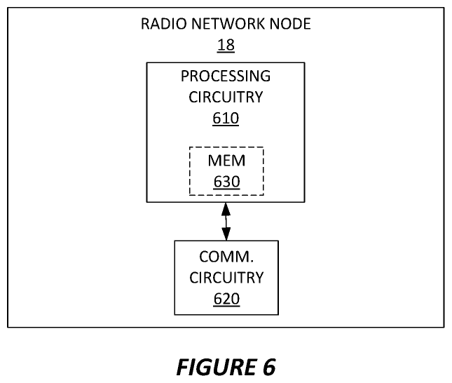

FIG. 6 for example illustrates a radio network node 18 as implemented in accordance with one or more embodiments. As shown, the radio network node 18 includes processing circuitry 610 and communication circuitry 620. The communication circuitry 620 (e.g., radio circuitry) is configured to transmit and/or receive information to and/or from one or more other nodes, e.g., via any communication technology. The processing circuitry 610 is configured to perform processing described above, e.g., in FIG. 4, such as by executing instructions stored in memory 630. The processing circuitry 610 in this regard may implement certain functional means, units, or modules.

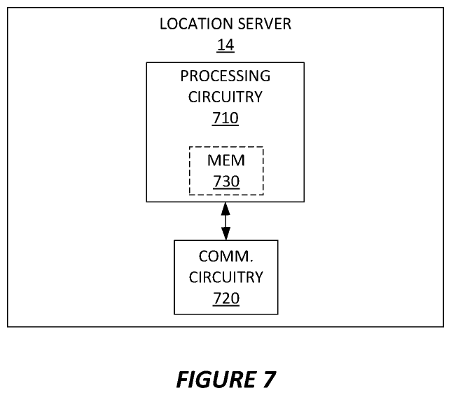

FIG. 7 illustrates a location server 14 as implemented in accordance with one or more embodiments. As shown, the location server 14 includes processing circuitry 710 and communication circuitry 720. The communication circuitry 720 is configured to transmit and/or receive information to and/or from one or more other nodes, e.g., via any communication technology. The processing circuitry 710 is configured to perform processing described above, e.g., in FIG. 5, such as by executing instructions stored in memory 730. The processing circuitry 710 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

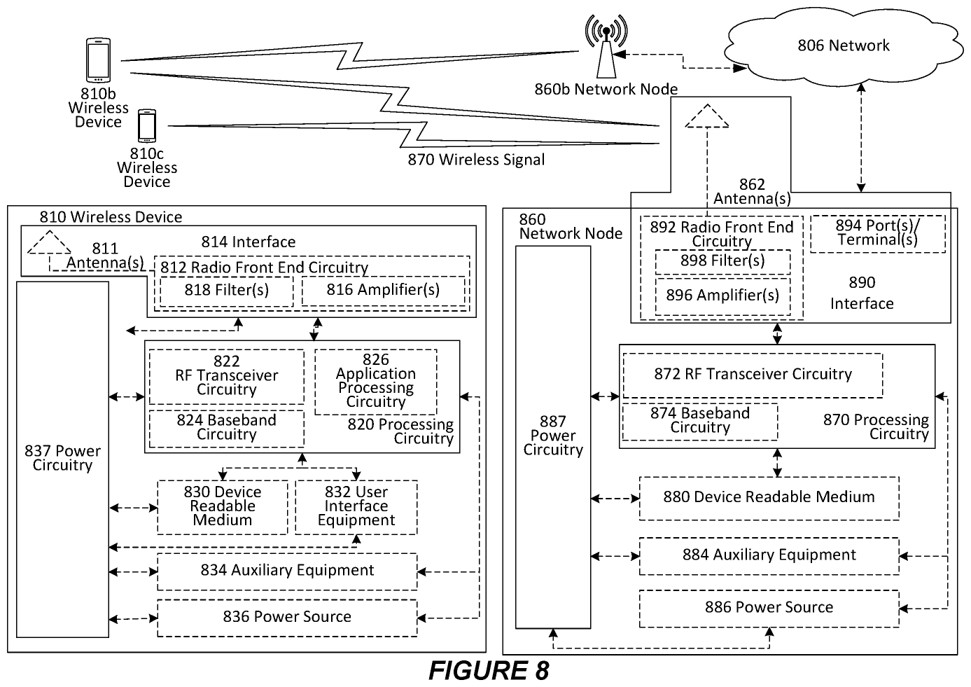

Although the subject matter described herein may be implemented in any appropriate type of system using any suitable components, the embodiments disclosed herein are described in relation to a wireless network, such as the example wireless network illustrated in FIG. 8. For simplicity, the wireless network of FIG. 8 only depicts network 806, network nodes 860 and 860b, and WDs 810, 810b, and 810c. In practice, a wireless network may further include any additional elements suitable to support communication between wireless devices or between a wireless device and another communication device, such as a landline telephone, a service provider, or any other network node or end device. Of the illustrated components, network node 860 and wireless device (WD) 810 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IOT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 806 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 860 and WD 810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 860 includes processing circuitry 870, device readable medium 880, interface 890, auxiliary equipment 884, power source 886, power circuitry 887, and antenna 862. Although network node 860 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 860 are depicted as single boxes located within a larger box, or nested within multiple boxes, in practice, a network node may comprise multiple different physical components that make up a single illustrated component (e.g., device readable medium 880 may comprise multiple separate hard drives as well as multiple RAM modules).

Similarly, network node 860 may be composed of multiple physically separate components (e.g., a NodeB component and a RNC component, or a BTS component and a BSC component, etc.), which may each have their own respective components. In certain scenarios in which network node 860 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 860 may be configured to support multiple radio access technologies (RATs). In such embodiments, some components may be duplicated (e.g., separate device readable medium 880 for the different RATs) and some components may be reused (e.g., the same antenna 862 may be shared by the RATs). Network node 860 may also include multiple sets of the various illustrated components for different wireless technologies integrated into network node 860, such as, for example, GSM, WCDMA, LTE, NR, WiFi, or Bluetooth wireless technologies. These wireless technologies may be integrated into the same or different chip or set of chips and other components within network node 860.

Processing circuitry 870 is configured to perform any determining, calculating, or similar operations (e.g., certain obtaining operations) described herein as being provided by a network node. These operations performed by processing circuitry 870 may include processing information obtained by processing circuitry 870 by, for example, converting the obtained information into other information, comparing the obtained information or converted information to information stored in the network node, and/or performing one or more operations based on the obtained information or converted information, and as a result of said processing making a determination.

Processing circuitry 870 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 860 components, such as device readable medium 880, network node 860 functionality. For example, processing circuitry 870 may execute instructions stored in device readable medium 880 or in memory within processing circuitry 870. Such functionality may include providing any of the various wireless features, functions, or benefits discussed herein. In some embodiments, processing circuitry 870 may include a system on a chip (SOC).

In some embodiments, processing circuitry 870 may include one or more of radio frequency (RF) transceiver circuitry 872 and baseband processing circuitry 874. In some embodiments, radio frequency (RF) transceiver circuitry 872 and baseband processing circuitry 874 may be on separate chips (or sets of chips), boards, or units, such as radio units and digital units. In alternative embodiments, part or all of RF transceiver circuitry 872 and baseband processing circuitry 874 may be on the same chip or set of chips, boards, or units

In certain embodiments, some or all of the functionality described herein as being provided by a network node, base station, eNB or other such network device may be performed by processing circuitry 870 executing instructions stored on device readable medium 880 or memory within processing circuitry 870. In alternative embodiments, some or all of the functionality may be provided by processing circuitry 870 without executing instructions stored on a separate or discrete device readable medium, such as in a hard-wired manner. In any of those embodiments, whether executing instructions stored on a device readable storage medium or not, processing circuitry 870 can be configured to perform the described functionality. The benefits provided by such functionality are not limited to processing circuitry 870 alone or to other components of network node 860, but are enjoyed by network node 860 as a whole, and/or by end users and the wireless network generally.

Device readable medium 880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 870. Device readable medium 880 may store any suitable instructions, data or information, including a computer program, software, an application including one or more of logic, rules, code, tables, etc. and/or other instructions capable of being executed by processing circuitry 870 and, utilized by network node 860. Device readable medium 880 may be used to store any calculations made by processing circuitry 870 and/or any data received via interface 890. In some embodiments, processing circuitry 870 and device readable medium 880 may be considered to be integrated.

Interface 890 is used in the wired or wireless communication of signalling and/or data between network node 860, network 806, and/or WDs 810. As illustrated, interface 890 comprises port(s)/terminal(s) 894 to send and receive data, for example to and from network 806 over a wired connection. Interface 890 also includes radio front end circuitry 892 that may be coupled to, or in certain embodiments a part of, antenna 862. Radio front end circuitry 892 comprises filters 898 and amplifiers 896. Radio front end circuitry 892 may be connected to antenna 862 and processing circuitry 870. Radio front end circuitry may be configured to condition signals communicated between antenna 862 and processing circuitry 870. Radio front end circuitry 892 may receive digital data that is to be sent out to other network nodes or WDs via a wireless connection. Radio front end circuitry 892 may convert the digital data into a radio signal having the appropriate channel and bandwidth parameters using a combination of filters 898 and/or amplifiers 896. The radio signal may then be transmitted via antenna 862. Similarly, when receiving data, antenna 862 may collect radio signals which are then converted into digital data by radio front end circuitry 892. The digital data may be passed to processing circuitry 870. In other embodiments, the interface may comprise different components and/or different combinations of components.

In certain alternative embodiments, network node 860 may not include separate radio front end circuitry 892, instead, processing circuitry 870 may comprise radio front end circuitry and may be connected to antenna 862 without separate radio front end circuitry 892. Similarly, in some embodiments, all or some of RF transceiver circuitry 872 may be considered a part of interface 890. In still other embodiments, interface 890 may include one or more ports or terminals 894, radio front end circuitry 892, and RF transceiver circuitry 872, as part of a radio unit (not shown), and interface 890 may communicate with baseband processing circuitry 874, which is part of a digital unit (not shown).

Antenna 862 may include one or more antennas, or antenna arrays, configured to send and/or receive wireless signals. Antenna 862 may be coupled to radio front end circuitry 890 and may be any type of antenna capable of transmitting and receiving data and/or signals wirelessly. In some embodiments, antenna 862 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 862 may be separate from network node 860 and may be connectable to network node 860 through an interface or port.

Antenna 862, interface 890, and/or processing circuitry 870 may be configured to perform any receiving operations and/or certain obtaining operations described herein as being performed by a network node. Any information, data and/or signals may be received from a wireless device, another network node and/or any other network equipment. Similarly, antenna 862, interface 890, and/or processing circuitry 870 may be configured to perform any transmitting operations described herein as being performed by a network node. Any information, data and/or signals may be transmitted to a wireless device, another network node and/or any other network equipment.

Power circuitry 887 may comprise, or be coupled to, power management circuitry and is configured to supply the components of network node 860 with power for performing the functionality described herein. Power circuitry 887 may receive power from power source 886. Power source 886 and/or power circuitry 887 may be configured to provide power to the various components of network node 860 in a form suitable for the respective components (e.g., at a voltage and current level needed for each respective component). Power source 886 may either be included in, or external to, power circuitry 887 and/or network node 860. For example, network node 860 may be connectable to an external power source (e.g., an electricity outlet) via an input circuitry or interface such as an electrical cable, whereby the external power source supplies power to power circuitry 887. As a further example, power source 886 may comprise a source of power in the form of a battery or battery pack which is connected to, or integrated in, power circuitry 887. The battery may provide backup power should the external power source fail. Other types of power sources, such as photovoltaic devices, may also be used.

Alternative embodiments of network node 860 may include additional components beyond those shown in FIG. 8 that may be responsible for providing certain aspects of the network node's functionality, including any of the functionality described herein and/or any functionality necessary to support the subject matter described herein. For example, network node 860 may include user interface equipment to allow input of information into network node 860 and to allow output of information from network node 860. This may allow a user to perform diagnostic, maintenance, repair, and other administrative functions for network node 860.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IOT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 810 includes antenna 811, interface 814, processing circuitry 820, device readable medium 830, user interface equipment 832, auxiliary equipment 834, power source 836 and power circuitry 837. WD 810 may include multiple sets of one or more of the illustrated components for different wireless technologies supported by WD 810, such as, for example, GSM, WCDMA, LTE, NR, WiFi, WIMAX, NB-IOT, or Bluetooth wireless technologies, just to mention a few. These wireless technologies may be integrated into the same or different chips or set of chips as other components within WD 810.

Antenna 811 may include one or more antennas or antenna arrays, configured to send and/or receive wireless signals, and is connected to interface 814. In certain alternative embodiments, antenna 811 may be separate from WD 810 and be connectable to WD 810 through an interface or port. Antenna 811, interface 814, and/or processing circuitry 820 may be configured to perform any receiving or transmitting operations described herein as being performed by a WD. Any information, data and/or signals may be received from a network node and/or another WD. In some embodiments, radio front end circuitry and/or antenna 811 may be considered an interface.

As illustrated, interface 814 comprises radio front end circuitry 812 and antenna 811. Radio front end circuitry 812 comprise one or more filters 818 and amplifiers 816. Radio front end circuitry 814 is connected to antenna 811 and processing circuitry 820, and is configured to condition signals communicated between antenna 811 and processing circuitry 820. Radio front end circuitry 812 may be coupled to or a part of antenna 811. In some embodiments, WD 810 may not include separate radio front end circuitry 812; rather, processing circuitry 820 may comprise radio front end circuitry and may be connected to antenna 811. Similarly, in some embodiments, some or all of RF transceiver circuitry 822 may be considered a part of interface 814. Radio front end circuitry 812 may receive digital data that is to be sent out to other network nodes or WDs via a wireless connection. Radio front end circuitry 812 may convert the digital data into a radio signal having the appropriate channel and bandwidth parameters using a combination of filters 818 and/or amplifiers 816. The radio signal may then be transmitted via antenna 811. Similarly, when receiving data, antenna 811 may collect radio signals which are then converted into digital data by radio front end circuitry 812. The digital data may be passed to processing circuitry 820. In other embodiments, the interface may comprise different components and/or different combinations of components.

Processing circuitry 820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 810 components, such as device readable medium 830, WD 810 functionality. Such functionality may include providing any of the various wireless features or benefits discussed herein. For example, processing circuitry 820 may execute instructions stored in device readable medium 830 or in memory within processing circuitry 820 to provide the functionality disclosed herein.

As illustrated, processing circuitry 820 includes one or more of RF transceiver circuitry 822, baseband processing circuitry 824, and application processing circuitry 826. In other embodiments, the processing circuitry may comprise different components and/or different combinations of components. In certain embodiments processing circuitry 820 of WD 810 may comprise a SOC. In some embodiments, RF transceiver circuitry 822, baseband processing circuitry 824, and application processing circuitry 826 may be on separate chips or sets of chips. In alternative embodiments, part or all of baseband processing circuitry 824 and application processing circuitry 826 may be combined into one chip or set of chips, and RF transceiver circuitry 822 may be on a separate chip or set of chips. In still alternative embodiments, part or all of RF transceiver circuitry 822 and baseband processing circuitry 824 may be on the same chip or set of chips, and application processing circuitry 826 may be on a separate chip or set of chips. In yet other alternative embodiments, part or all of RF transceiver circuitry 822, baseband processing circuitry 824, and application processing circuitry 826 may be combined in the same chip or set of chips. In some embodiments, RF transceiver circuitry 822 may be a part of interface 814. RF transceiver circuitry 822 may condition RF signals for processing circuitry 820.

In certain embodiments, some or all of the functionality described herein as being performed by a WD may be provided by processing circuitry 820 executing instructions stored on device readable medium 830, which in certain embodiments may be a computer-readable storage medium. In alternative embodiments, some or all of the functionality may be provided by processing circuitry 820 without executing instructions stored on a separate or discrete device readable storage medium, such as in a hard-wired manner. In any of those particular embodiments, whether executing instructions stored on a device readable storage medium or not, processing circuitry 820 can be configured to perform the described functionality. The benefits provided by such functionality are not limited to processing circuitry 820 alone or to other components of WD 810, but are enjoyed by WD 810 as a whole, and/or by end users and the wireless network generally.

Processing circuitry 820 may be configured to perform any determining, calculating, or similar operations (e.g., certain obtaining operations) described herein as being performed by a WD. These operations, as performed by processing circuitry 820, may include processing information obtained by processing circuitry 820 by, for example, converting the obtained information into other information, comparing the obtained information or converted information to information stored by WD 810, and/or performing one or more operations based on the obtained information or converted information, and as a result of said processing making a determination.

Device readable medium 830 may be operable to store a computer program, software, an application including one or more of logic, rules, code, tables, etc. and/or other instructions capable of being executed by processing circuitry 820. Device readable medium 830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 820. In some embodiments, processing circuitry 820 and device readable medium 830 may be considered to be integrated.

User interface equipment 832 may provide components that allow for a human user to interact with WD 810. Such interaction may be of many forms, such as visual, audial, tactile, etc. User interface equipment 832 may be operable to produce output to the user and to allow the user to provide input to WD 810. The type of interaction may vary depending on the type of user interface equipment 832 installed in WD 810. For example, if WD 810 is a smart phone, the interaction may be via a touch screen; if WD 810 is a smart meter, the interaction may be through a screen that provides usage (e.g., the number of gallons used) or a speaker that provides an audible alert (e.g., if smoke is detected). User interface equipment 832 may include input interfaces, devices and circuits, and output interfaces, devices and circuits. User interface equipment 832 is configured to allow input of information into WD 810, and is connected to processing circuitry 820 to allow processing circuitry 820 to process the input information. User interface equipment 832 may include, for example, a microphone, a proximity or other sensor, keys/buttons, a touch display, one or more cameras, a USB port, or other input circuitry. User interface equipment 832 is also configured to allow output of information from WD 810, and to allow processing circuitry 820 to output information from WD 810. User interface equipment 832 may include, for example, a speaker, a display, vibrating circuitry, a USB port, a headphone interface, or other output circuitry. Using one or more input and output interfaces, devices, and circuits, of user interface equipment 832, WD 810 may communicate with end users and/or the wireless network, and allow them to benefit from the functionality described herein.

Auxiliary equipment 834 is operable to provide more specific functionality which may not be generally performed by WDs. This may comprise specialized sensors for doing measurements for various purposes, interfaces for additional types of communication such as wired communications etc. The inclusion and type of components of auxiliary equipment 834 may vary depending on the embodiment and/or scenario.

Power source 836 may, in some embodiments, be in the form of a battery or battery pack. Other types of power sources, such as an external power source (e.g., an electricity outlet), photovoltaic devices or power cells, may also be used. WD 810 may further comprise power circuitry 837 for delivering power from power source 836 to the various parts of WD 810 which need power from power source 836 to carry out any functionality described or indicated herein. Power circuitry 837 may in certain embodiments comprise power management circuitry. Power circuitry 837 may additionally or alternatively be operable to receive power from an external power source; in which case WD 810 may be connectable to the external power source (such as an electricity outlet) via input circuitry or an interface such as an electrical power cable. Power circuitry 837 may also in certain embodiments be operable to deliver power from an external power source to power source 836. This may be, for example, for the charging of power source 836. Power circuitry 837 may perform any formatting, converting, or other modification to the power from power source 836 to make the power suitable for the respective components of WD 810 to which power is supplied.

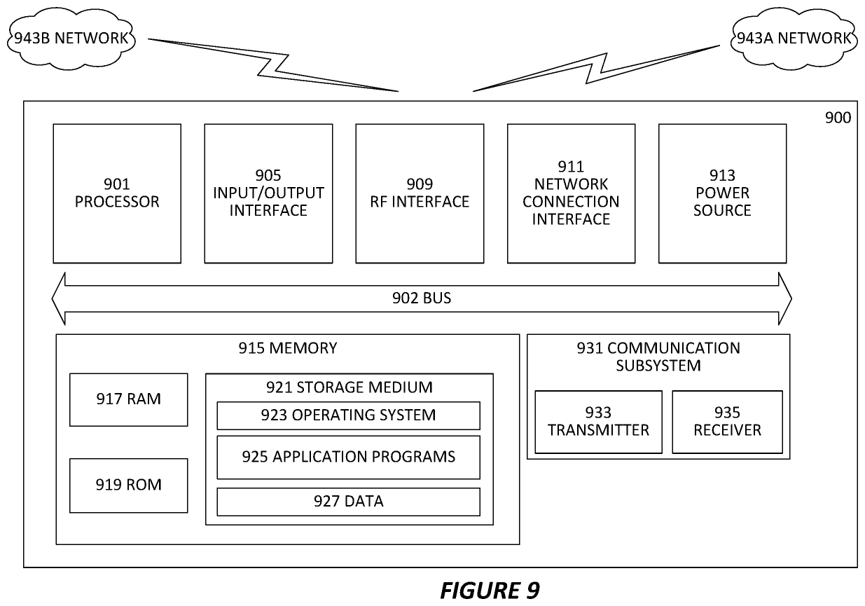

FIG. 9 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 9200 may be any UE identified by the 3rd Generation Partnership Project (3GPP), including a NB-IOT UE, a machine type communication (MTC) UE, and/or an enhanced MTC (eMTC) UE. UE 900, as illustrated in FIG. 9, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 9 is a UE, the components discussed herein are equally applicable to a WD, and vice-versa.

In FIG. 9, UE 900 includes processing circuitry 901 that is operatively coupled to input/output interface 905, radio frequency (RF) interface 909, network connection interface 911, memory 915 including random access memory (RAM) 917, read-only memory (ROM) 919, and storage medium 921 or the like, communication subsystem 931, power source 933, and/or any other component, or any combination thereof. Storage medium 921 includes operating system 923, application program 925, and data 927. In other embodiments, storage medium 921 may include other similar types of information. Certain UEs may utilize all of the components shown in FIG. 9, or only a subset of the components. The level of integration between the components may vary from one UE to another UE. Further, certain UEs may contain multiple instances of a component, such as multiple processors, memories, transceivers, transmitters, receivers, etc.

In FIG. 9, processing circuitry 901 may be configured to process computer instructions and data. Processing circuitry 901 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 901 may include two central processing units (CPUs). Data may be information in a form suitable for use by a computer.

In the depicted embodiment, input/output interface 905 may be configured to provide a communication interface to an input device, output device, or input and output device. UE 900 may be configured to use an output device via input/output interface 905. An output device may use the same type of interface port as an input device. For example, a USB port may be used to provide input to and output from UE 900. The output device may be a speaker, a sound card, a video card, a display, a monitor, a printer, an actuator, an emitter, a smartcard, another output device, or any combination thereof. UE 900 may be configured to use an input device via input/output interface 905 to allow a user to capture information into UE 900. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 9, RF interface 909 may be configured to provide a communication interface to RF components such as a transmitter, a receiver, and an antenna. Network connection interface 911 may be configured to provide a communication interface to network 943a. Network 943a may encompass wired and/or wireless networks such as a local-area network (LAN), a wide-area network (WAN), a computer network, a wireless network, a telecommunications network, another like network or any combination thereof. For example, network 943a may comprise a Wi-Fi network. Network connection interface 911 may be configured to include a receiver and a transmitter interface used to communicate with one or more other devices over a communication network according to one or more communication protocols, such as Ethernet, TCP/IP, SONET, ATM, or the like. Network connection interface 911 may implement receiver and transmitter functionality appropriate to the communication network links (e.g., optical, electrical, and the like). The transmitter and receiver functions may share circuit components, software or firmware, or alternatively may be implemented separately.

RAM 917 may be configured to interface via bus 902 to processing circuitry 901 to provide storage or caching of data or computer instructions during the execution of software programs such as the operating system, application programs, and device drivers. ROM 919 may be configured to provide computer instructions or data to processing circuitry 901. For example, ROM 919 may be configured to store invariant low-level system code or data for basic system functions such as basic input and output (I/O), startup, or reception of keystrokes from a keyboard that are stored in a non-volatile memory. Storage medium 921 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 921 may be configured to include operating system 923, application program 925 such as a web browser application, a widget or gadget engine or another application, and data file 927. Storage medium 921 may store, for use by UE 900, any of a variety of various operating systems or combinations of operating systems.

Storage medium 921 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 921 may allow UE 900 to access computer-executable instructions, application programs or the like, stored on transitory or non-transitory memory media, to off-load data, or to upload data. An article of manufacture, such as one utilizing a communication system may be tangibly embodied in storage medium 921, which may comprise a device readable medium.

In FIG. 9, processing circuitry 901 may be configured to communicate with network 943b using communication subsystem 931. Network 943a and network 943b may be the same network or networks or different network or networks. Communication subsystem 931 may be configured to include one or more transceivers used to communicate with network 943b. For example, communication subsystem 931 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 933 and/or receiver 935 to implement transmitter or receiver functionality, respectively, appropriate to the RAN links (e.g., frequency allocations and the like). Further, transmitter 933 and receiver 935 of each transceiver may share circuit components, software or firmware, or alternatively may be implemented separately.

In the illustrated embodiment, the communication functions of communication subsystem 931 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 931 may include cellular communication, Wi-Fi communication, Bluetooth communication, and GPS communication. Network 943b may encompass wired and/or wireless networks such as a local-area network (LAN), a wide-area network (WAN), a computer network, a wireless network, a telecommunications network, another like network or any combination thereof. For example, network 943b may be a cellular network, a Wi-Fi network, and/or a near-field network. Power source 913 may be configured to provide alternating current (AC) or direct current (DC) power to components of UE 900.

The features, benefits and/or functions described herein may be implemented in one of the components of UE 900 or partitioned across multiple components of UE 900. Further, the features, benefits, and/or functions described herein may be implemented in any combination of hardware, software or firmware. In one example, communication subsystem 931 may be configured to include any of the components described herein. Further, processing circuitry 901 may be configured to communicate with any of such components over bus 902. In another example, any of such components may be represented by program instructions stored in memory that when executed by processing circuitry 901 perform the corresponding functions described herein. In another example, the functionality of any of such components may be partitioned between processing circuitry 901 and communication subsystem 931. In another example, the non-computationally intensive functions of any of such components may be implemented in software or firmware and the computationally intensive functions may be implemented in hardware.

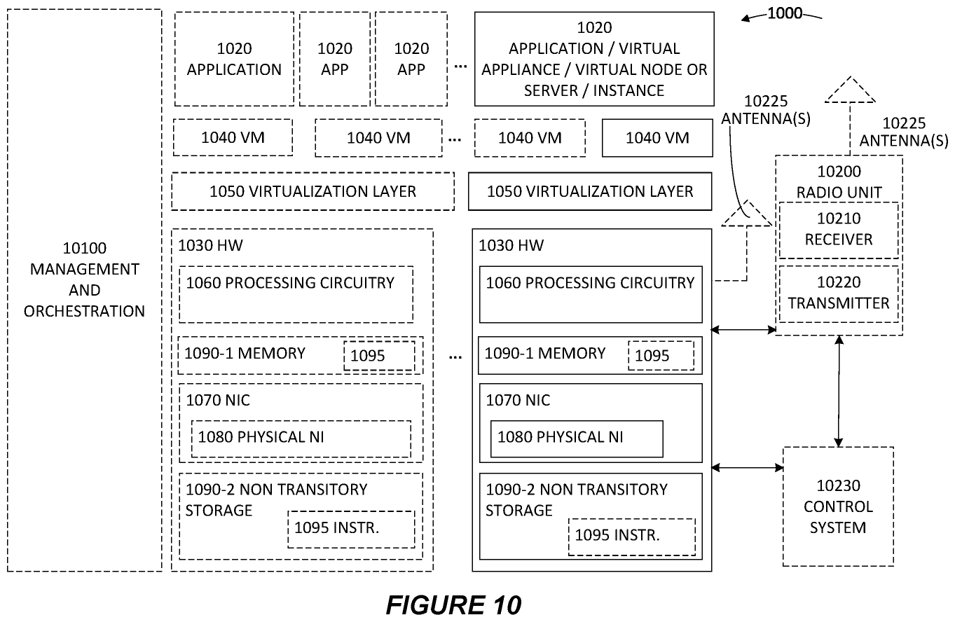

FIG. 10 is a schematic block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1000 hosted by one or more of hardware nodes 1030. Further, in embodiments in which the virtual node is not a radio access node or does not require radio connectivity (e.g., a core network node), then the network node may be entirely virtualized.

The functions may be implemented by one or more applications 1020 (which may alternatively be called software instances, virtual appliances, network functions, virtual nodes, virtual network functions, etc.) operative to implement some of the features, functions, and/or benefits of some of the embodiments disclosed herein. Applications 1020 are run in virtualization environment 1000 which provides hardware 1030 comprising processing circuitry 1060 and memory 1090. Memory 1090 contains instructions 1095 executable by processing circuitry 1060 whereby application 1020 is operative to provide one or more of the features, benefits, and/or functions disclosed herein.

Virtualization environment 1000, comprises general-purpose or special-purpose network hardware devices 1030 comprising a set of one or more processors or processing circuitry 1060, which may be commercial off-the-shelf (COTS) processors, dedicated Application Specific Integrated Circuits (ASICs), or any other type of processing circuitry including digital or analog hardware components or special purpose processors. Each hardware device may comprise memory 1090-1 which may be non-persistent memory for temporarily storing instructions 1095 or software executed by processing circuitry 1060. Each hardware device may comprise one or more network interface controllers (NICs) 1070, also known as network interface cards, which include physical network interface 1080. Each hardware device may also include non-transitory, persistent, machine-readable storage media 1090-2 having stored therein software 1095 and/or instructions executable by processing circuitry 1060. Software 1095 may include any type of software including software for instantiating one or more virtualization layers 1050 (also referred to as hypervisors), software to execute virtual machines 1040 as well as software allowing it to execute functions, features and/or benefits described in relation with some embodiments described herein.

Virtual machines 1040, comprise virtual processing, virtual memory, virtual networking or interface and virtual storage, and may be run by a corresponding virtualization layer 1050 or hypervisor. Different embodiments of the instance of virtual appliance 1020 may be implemented on one or more of virtual machines 1040, and the implementations may be made in different ways.

During operation, processing circuitry 1060 executes software 1095 to instantiate the hypervisor or virtualization layer 1050, which may sometimes be referred to as a virtual machine monitor (VMM). Virtualization layer 1050 may present a virtual operating platform that appears like networking hardware to virtual machine 1040.

As shown in FIG. 10, hardware 1030 may be a standalone network node with generic or specific components. Hardware 1030 may comprise antenna 10225 and may implement some functions via virtualization. Alternatively, hardware 1030 may be part of a larger cluster of hardware (e.g. such as in a data center or customer premise equipment (CPE)) where many hardware nodes work together and are managed via management and orchestration (MANO) 10100, which, among others, oversees lifecycle management of applications 1020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1040 may be a software implementation of a physical machine that runs programs as if they were executing on a physical, non-virtualized machine. Each of virtual machines 1040, and that part of hardware 1030 that executes that virtual machine, be it hardware dedicated to that virtual machine and/or hardware shared by that virtual machine with others of the virtual machines 1040, forms a separate virtual network elements (VNE).

Still in the context of NFV, Virtual Network Function (VNF) is responsible for handling specific network functions that run in one or more virtual machines 1040 on top of hardware networking infrastructure 1030 and corresponds to application 1020 in FIG. 10.

In some embodiments, one or more radio units 10200 that each include one or more transmitters 10220 and one or more receivers 10210 may be coupled to one or more antennas 10225. Radio units 10200 may communicate directly with hardware nodes 1030 via one or more appropriate network interfaces and may be used in combination with the virtual components to provide a virtual node with radio capabilities, such as a radio access node or a base station.

In some embodiments, some signalling can be effected with the use of control system 10230 which may alternatively be used for communication between the hardware nodes 1030 and radio units 10200.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a radio network node configured for use in a wireless communication network, the method comprising:
   receiving, from a location server for the wireless communication network, a request for the radio network node to report measurements usable to compute a location of a wireless device; and
   transmitting, to the location server, a message that indicates the radio network node is unable to report the measurements and that indicates a cause of the radio network node being unable to report the measurements, wherein the indicated cause is the wireless device entering a specified state and/or is unavailability of a context for the wireless device at the radio network node.
A2. The method of embodiment A1, wherein the specified state is a radio resource control inactive state.
A3. The method of embodiment A1, wherein the specified state is a radio resource control idle state.
A4. The method of any of embodiments A1-A3, wherein the indicated cause is unavailability of the context for the wireless device due to the context being moved to another radio network node.
A5. The method of any of embodiments A1-A3, wherein the indicated cause is unavailability of the context for the wireless device due to the context being released by the radio network node.
A6. The method of any of embodiments A1-A5, wherein the measurements are enhanced cell identity, E-CID, measurements.
A7. The method of any of embodiments A1-A6, wherein the received request is a measurement initiation request.
A8. The method of any of embodiments A1-A7, wherein the transmitted message indicates the radio network node is unable to report the measurements by indicating that the radio network node is unable to initiate any of the measurements or is unable to instigate required radio resource control procedures to obtain the measurements from the wireless device.
A9. The method of any of embodiments A1-A8, wherein the transmitted message is a measurement initiation failure message or a measurement failure indication.
A10. The method of any of embodiments A1-A9, wherein the request is received and/or the message is transmitted using a Positioning Protocol between the radio network node and the location server.
A11. The method of any of embodiments A1-A10, wherein the transmitted message includes a cause field that indicates the cause.
A12. The method of embodiment A11, wherein the cause field is configurable to have any value included in a set of possible values, wherein the set of possible values comprises two or more of:
   a first value indicating the cause as the wireless device entering a radio resource control inactive state;
   a second value indicating the cause as being the context for the wireless device having moved to another radio network node; and
   a third value indicating the cause as being the context for the wireless device having been released at the radio network node and/or the wireless device having entered a radio resource control idle state.
A13. The method of embodiment A12, wherein the first value is “UE in RRC_INACTIVE state”, wherein the second value is “UE Context moved”, and wherein the third value is “UE Context released”.
A14. The method of any of embodiments A1-A13, further comprising:
   responsive to receiving the request, determining whether the radio network node is able to report the measurements; and
   based on determining that the radio network node is unable to report the measurements, determining a cause of the radio network node being unable to report the measurements; and
   generating the message to be transmitted to indicate the determined cause.
AA. The method of any of the previous embodiments, further comprising:
   providing user data; and
   forwarding the user data to a host computer via the transmission to a base station.

### Group B Embodiments

B1. A method performed by a location server configured for use in a wireless communication network, the method comprising:
   transmitting, from the location server to a radio network node in the wireless communication network, a request for the radio network node to report measurements usable to compute a location of a wireless device; and
   receiving, from the radio network node, a message that indicates the radio network node is unable to report the measurements and that indicates a cause of the radio network node being unable to report the measurements, wherein the indicated cause is the wireless device entering a specified state and/or is unavailability of a context for the wireless device at the radio network node.
B2. The method of embodiment B1, wherein the specified state is a radio resource control inactive state.
B3. The method of embodiment B1, wherein the specified state is a radio resource control idle state.
B4. The method of any of embodiments B1-B3, wherein the indicated cause is unavailability of the context for the wireless device due to the context being moved to another radio network node.
B5. The method of any of embodiments B1-B3, wherein the indicated cause is unavailability of the context for the wireless device due to the context being released by the radio network node.
B6. The method of any of embodiments B1-B5, wherein the measurements are enhanced cell identity, E-CID, measurements.
B7. The method of any of embodiments B1-B6, wherein the transmitted request is a measurement initiation request.
B8. The method of any of embodiments B1-B7, wherein the received message indicates the radio network node is unable to report the measurements by indicating that the radio network node is unable to initiate any of the measurements or is unable to instigate required radio resource control procedures to obtain the measurements from the wireless device.
B9. The method of any of embodiments B1-B8, wherein the received message is a measurement initiation failure message or a measurement failure indication.
B10. The method of any of embodiments B1-B9, wherein the request is transmitted and/or the message is received using a Positioning Protocol between the radio network node and the location server.
B11. The method of any of embodiments B1-B10, wherein the received message includes a cause field that indicates the cause.
B12. The method of embodiment B11, wherein the cause field is configurable to have any value included in a set of possible values, wherein the set of possible values comprises two or more of:
   a first value indicating the cause as the wireless device entering a radio resource control inactive state;
   a second value indicating the cause as being the context for the wireless device having moved to another radio network node; and
   a third value indicating the cause as being the context for the wireless device having been released at the radio network node and/or the wireless device having entered a radio resource control idle state.
B13. The method of embodiment B12, wherein the first value is “UE in RRC_INACTIVE state”, wherein the second value is “UE Context moved”, and wherein the third value is “UE Context released”.
B14. The method of any of embodiments B1-B13, further comprising storing the received message and/or information indicating the cause of the radio network node being unable to report the measurements.
B15. The method of any of embodiments B1-B14, further comprising, responsive to receiving the message, adapting a timing of when the radio network node is to report measurements usable to compute a location of the wireless device.
B16. The method of embodiment B15, wherein said adapting comprises increasing a time interval between which the radio network node is to report measurements usable to compute a location of the wireless device.
B17. The method of any of embodiments B1-B14, further comprising, responsive to receiving the message, either:
   adapting a time interval between which the location server transmits requests to the radio network node for the radio network node to report measurements usable to compute a location of the wireless device;
   transmitting, to the radio network node, another request that requests the radio network node to periodically report measurements usable to compute a location of the wireless device according to a periodic interval that is different than a previous periodic interval indicated by a previous request transmitted to the radio network node before receiving the message.
B18. The method of any of embodiments B15-B17, wherein the indicated cause is the wireless device entering a radio resource control inactive state.
B19. The method of any of embodiments B1-B14, wherein the indicated cause is the context for the wireless device having moved to another radio network node, and wherein the method further comprises, responsive to receiving the message, transmitting, to the another radio network node, a request for the another radio network node to report measurements usable to compute a location of the wireless device.
B20. The method of any of embodiments B1-B14, wherein the indicated cause is the context for the wireless device having been released at the radio network node and/or the wireless device having entered a radio resource control idle state, and wherein the method further comprises, responsive to receiving the message, either:
   transmitting, to another radio network node, a request for the another radio network node to report measurements usable to compute a location of the wireless device; or
   waiting to send another request, to the same or a different radio network node, until the wireless device enters a radio resource control connected state.
BB. The method of any of the previous embodiments, further comprising:
   obtaining user data; and
   forwarding the user data to a host computer or a wireless device.

### Group C Embodiments

C1. A radio network node configured to perform any of the steps of any of the Group A embodiments.
C2. A radio network node comprising processing circuitry configured to perform any of the steps of any of the Group A embodiments.
C3. A radio network node comprising:
   communication circuitry; and
   processing circuitry configured to perform any of the steps of any of the Group A embodiments.
C4. A radio network node comprising:
   processing circuitry configured to perform any of the steps of any of the Group A embodiments; and
   power supply circuitry configured to supply power to the radio network node.
C5. A radio network node comprising:
   processing circuitry and memory, the memory containing instructions executable by the processing circuitry whereby the radio network node is configured to perform any of the steps of any of the Group A embodiments.
C6. Reserved.
C7. A computer program comprising instructions which, when executed by at least one processor of a radio network node, causes the radio network node to carry out the steps of any of the Group A embodiments.
C8. A carrier containing the computer program of embodiment C7, wherein the carrier is one of an electronic signal, optical signal, radio signal, or computer readable storage medium.
C9. A location server configured to perform any of the steps of any of the Group B embodiments.
C10. A location server comprising processing circuitry configured to perform any of the steps of any of the Group B embodiments.
C11. A location server comprising:
   communication circuitry; and
   processing circuitry configured to perform any of the steps of any of the Group B embodiments.
C12. A location server comprising:
   processing circuitry configured to perform any of the steps of any of the Group B embodiments;
   power supply circuitry configured to supply power to the location server.
C13. A location server comprising:
   processing circuitry and memory, the memory containing instructions executable by the processing circuitry whereby the location server is configured to perform any of the steps of any of the Group B embodiments.
C14. A computer program comprising instructions which, when executed by at least one processor of a location server, causes the location server to carry out the steps of any of the Group B embodiments.
C15. A carrier containing the computer program of any of embodiments C15-C16, wherein the carrier is one of an electronic signal, optical signal, radio signal, or computer readable storage

1.-28. (canceled)

29. A method performed by a radio network node configured for use in a wireless communication network, the method comprising:
receiving, from a location server for the wireless communication network, a request for the radio network node to report measurements usable to compute a location of a wireless device; and
transmitting, to the location server, a message that indicates the radio network node is unable to report the measurements and that indicates a cause of the radio network node being unable to report the measurements, wherein the indicated cause is that the wireless device has moved to another radio network node.

30. The method of claim 29, wherein the measurements are enhanced cell identity (E-CID) measurements.

31. The method of claim 29, wherein the received request is a measurement initiation request, and/or the transmitted message is a measurement initiation failure message or a measurement failure indication.

32. The method of claim 29, wherein the transmitted message indicates the radio network node is unable to report the measurements by indicating that the radio network node is unable to initiate any of the measurements or is unable to instigate required radio resource control procedures to obtain the measurements from the wireless device.

33. The method of claim 29, wherein the request is received and/or the message is transmitted using a Positioning Protocol between the radio network node and the location server.

34. The method of claim 29, wherein the transmitted message indicates the cause from a radio network layer perspective.

35. The method of claim 29, further comprising:
responsive to receiving the request, determining whether the radio network node is able to report the measurements; and
based on determining that the radio network node is unable to report the measurements, determining a cause of the radio network node being unable to report the measurements; and
generating the message to be transmitted to indicate the determined cause.

36. A method performed by a location server configured for use in a wireless communication network, the method comprising:
transmitting, from the location server to a radio network node in the wireless communication network, a request for the radio network node to report measurements usable to compute a location of a wireless device; and
receiving, from the radio network node, a message that indicates the radio network node is unable to report the measurements and that indicates a cause of the radio network node being unable to report the measurements, wherein the indicated cause is that the wireless device has moved to another radio network node.

37. The method of claim 36, wherein the measurements are enhanced cell identity (E-CID) measurements.

38. The method of claim 36, wherein the transmitted request is a measurement initiation request, and/or the received message is a measurement initiation failure message or a measurement failure indication.

39. The method of claim 36, wherein the received message indicates the radio network node is unable to report the measurements by indicating that the radio network node is unable to initiate any of the measurements or is unable to instigate required radio resource control procedures to obtain the measurements from the wireless device.

40. The method of claim 36, wherein the received message indicates the cause from a radio network layer perspective.

41. The method of claim 36, further comprising:
storing the received message and/or information indicating the cause of the radio network node being unable to report the measurements; and/or
responsive to receiving the message, transmitting, to the another radio network node, a request for the another radio network node to report measurements usable to compute a location of the wireless device.

42. A radio network node configured for use in a wireless communication network, the radio network node comprising:
communication circuitry; and
processing circuitry configured to:
receive, from a location server for the wireless communication network, a request for the radio network node to report measurements usable to compute a location of a wireless device; and
transmit, to the location server, a message that indicates the radio network node is unable to report the measurements and that indicates a cause of the radio network node being unable to report the measurements, wherein the indicated cause is that the wireless device has moved to another radio network node.

43. The radio network node of claim 42, wherein the measurements are enhanced cell identity (E-CID) measurements.

44. The radio network node of claim 42, wherein the received request is a measurement initiation request, and/or the transmitted message is a measurement initiation failure message or a measurement failure indication.

45. The radio network node of claim 42, wherein the transmitted message indicates the radio network node is unable to report the measurements by indicating that the radio network node is unable to initiate any of the measurements or is unable to instigate required radio resource control procedures to obtain the measurements from the wireless device.

46. The radio network node of claim 42, wherein the request is received and/or the message is transmitted using a Positioning Protocol between the radio network node and the location server.

47. The radio network node of claim 42, wherein the transmitted message indicates the cause from a radio network layer perspective.

48. The radio network node of claim 42, wherein the processing circuitry is further configured to:
responsive to receiving the request, determine whether the radio network node is able to report the measurements; and
based on determining that the radio network node is unable to report the measurements, determine a cause of the radio network node being unable to report the measurements; and
generate the message to be transmitted to indicate the determined cause.

49. A location server configured for use in a wireless communication network, the location server comprising:
communication circuitry; and
processing circuitry configured to:
transmit, from the location server to a radio network node in the wireless communication network, a request for the radio network node to report measurements usable to compute a location of a wireless device; and
receive, from the radio network node, a message that indicates the radio network node is unable to report the measurements and that indicates a cause of the radio network node being unable to report the measurements, wherein the indicated cause is that the wireless device has moved to another radio network node.

50. The location server of claim 49, wherein the measurements are enhanced cell identity (E-CID) measurements.

51. The location server of claim 49, wherein the transmitted request is a measurement initiation request, and/or the received message is a measurement initiation failure message or a measurement failure indication.

52. The location server of claim 49, wherein the received message indicates the radio network node is unable to report the measurements by indicating that the radio network node is unable to initiate any of the measurements or is unable to instigate required radio resource control procedures to obtain the measurements from the wireless device.

53. The location server of claim 49, wherein the received message indicates the cause from a radio network layer perspective.

54. The location server of claim 49, wherein the processing circuitry is further configured to:
store the received message and/or information indicating the cause of the radio network node being unable to report the measurements; and/or
responsive to receiving the message, transmit, to the another radio network node, a request for the another radio network node to report measurements usable to compute a location of the wireless device.
